(19) United States
(12) Patent Application Publication
(10) Pub. No.: US 2013/0265258 A1
(43) Pub. Date: Oct. 10, 2013

(54) METHOD FOR IDENTIFYING TOUCH ON A TOUCH SCREEN

(71) Applicant: N-TRIG LTD., Kfar-Saba (IL)

(72) Inventors: Gadi Garfinkel, Yahud (IL); Arthur Gershfeld, Akko (IL); Amir Zyskind, Natania (IL); On Haran, Kfar-Saba (IL); Eytan Mann, Modiln (IL)

(21) Appl. No.: 13/858,169

(22) Filed: Apr. 8, 2013

Related U.S. Application Data
(60) Provisional application No. 61/621,530, filed on Apr. 8, 2012.

(51) Int. Cl. G06F 3/041

(52) U.S. Cl. CPC G06F 3/0416
USPC 345/173; 178/18.03

(57) ABSTRACT

A method for identifying input to a grid based digitizer sensor includes defining a matrix of data from outputs sampled from digitizer sensor, defining a function for modeling spread of a touch signal around a touch location and performing a convolution operation on the matrix of data based on the function defined for modeling spread of the touch signal. The grid based digitizer sensor defines a grid of junctions and entries in the matrix correspond to outputs at junctions of the grid based sensor. The convolution operation provides an updated matrix of data with enhanced touch information and detecting coordinates of the input to the digitizer sensor from the updated matrix of data.

### RELATED APPLICATION

This application claims the benefit of priority under 35 USC §119(e) of U.S. Provisional Patent Application No. 61/621,530 filed Apr. 8, 2012, the contents of which are incorporated herein by reference in their entirety.

### FIELD AND BACKGROUND OF THE INVENTION

The present invention, in some embodiments thereof, relates to touch screens and, more particularly, but not exclusively, to touch detection with a touch screen.

Touch screens are commonly used as input devices for a variety of electronic products and for a variety of different applications. Touch screens are often used for operating portable devices, such as Personal Digital Assistants (PDA), tablet PCs, wireless flat panel displays (FPD) screens, laptop computers, smart phones and other devices. Touch screens are known to allow a user to interact with an electronic product in more intuitive and versatile manner as compared to other known input devices. Touch screens can be used for example to select virtual buttons displayed on the screen, to manipulate size and position of displayed objects, to enter data with a virtual keyboard, virtual number pad and/or by handwritten input, to open a document or application, to scroll within a window, to draw and/or to play games. Some touch screens support multi-touch operations where multiple simultaneous touches can be used to provide input. Multi-touch operations can be used to perform more advance operations with a touch screen.

U.S. Pat. No. 7,372,455 entitled “Touch Detection for a Digitizer,” assigned to N-trig, the content of which is incorporated herein by reference describes a multi-touch detection apparatus that is operative to distinguish between more than one finger touch interacting with the apparatus at the same time. The apparatus includes a transparent sensor formed with a grid array of conductors. The grid array includes conductors in a first direction and conductors in a second direction that form a plurality of junctions at which the conductors do not contact. An oscillator provides an oscillation signal to conductors in said first direction and detection circuitry detects the oscillation signal when transferred via the junctions to conductors in the second direction. The transference is disclosed as being indicative of capacitive coupling induced by an object touching the sensor at a respective junction. It is described that a tabulation of leakage capacitance values for each junction is determined and is used to correct output detected from the second set of conductors.

U.S. Pat. No. 6,323,846 entitled “Method and Apparatus for Integrating Manual Input,” the content of which is incorporated herein by reference describes an apparatus and method for simultaneously tracking multiple finger and palm contacts on a proximity-sensing multi-touch surface including an electrode array. It is disclosed that scanning and signal offset removal on the electrode array produces low-noise proximity images. Segmentation processing of each proximity image constructs a group of electrodes corresponding to each distinguishable contact and extracts shape, position and surface proximity features for each group. Edge detection rules are applied for the segmentation processing. Groups in successive images which correspond to the same hand contact are linked by a persistent path tracker which also detects individual contact touchdown and liftoff.

U.S. Patent Application Publication No. 2009-0095540 entitled “Method for Palm Touch Identification in Multi-Touch Digitizing Systems,” assigned to N-trig, the content of which is incorporated herein by reference describes a method for differentiating between input obtained from a hand part other than a fingertip and input obtained from a fingertip. The method includes identifying a plurality of discrete regions of input to a digitizer sensor, identifying one of the discrete regions as a palm input region and another discrete region as a potential fingertip input region and disqualifying the potential fingertip input region if it is within pre-defined distance from the identified palm region. Typically, the palm input region and the potential fingertip input regions may be identified at least based on their size.

### SUMMARY OF THE INVENTION

According to an aspect of some embodiments of the present invention there is provided a method for applying image processing techniques on output obtained from a digitizer sensor to improve the ability to differentiate between a plurality of touches on the digitizer sensor.

As the usage of touch screens increases and the sensor technologies advance, the demand for touch screens that can support multi-touch input is increasing. While traditional applications, such as e-mail or web browsing can be well operated using a single touch input, more advanced applications, including, for example, graphic applications, may benefit from receiving multi-touch input. In addition to touch information, it may also be beneficial for some applications to obtain information regarding objects, e.g. fingertips, styluses and/or hands hovering in close proximity to the digitizer sensor. Further, many applications or operating systems can potentially make use of gestures input that include multi-touch sequences.

Multi-touch interaction with a digitizer sensor poses a number of challenges, including for example determining how many concurrent interactions have been made and identifying location of each interaction. While concurrent interactions that are well spaced apart may be easily identified and located, other concurrent interactions that are in closer proximity may be more difficult to identify and/or locate. At times, concurrent interactions in close proximity may be confused with input from a larger object or body part, e.g. a palm, cheek, ear or elbow which was not intended for providing input to the digitizer sensor. It is to be understood that the ability to differentiate between concurrent touches can depend on a plurality of factors including for example proximity between the concurrent touches, size of the objects concurrently touching with the digitizer sensor and the resolution of the digitizer sensor.

An aspect of some embodiments of the present invention provides for a method for identifying input to a digitizer sensor, the method including: defining a function for modeling spread of a touch signal around a touch location; defining a matrix of data from outputs sampled from a grid based digitizer sensor, wherein the grid based digitizer sensor defines a grid of junctions, and wherein entries in the matrix correspond to outputs at junctions of the grid based sensor; performing a convolution operation on the matrix of data based on the function defined for modeling spread of the touch signal, the convolution operation providing an updated matrix of data with enhanced touch information; and detecting coordinates of the input to the digitizer sensor from the updated matrix of data.

Optionally, the function for modeling spread of a touch signal around a touch location is a two dimensional function that defines the spread of a touch signal along a first and second axis of the grid based sensor.

Optionally, the function for modeling spread of a touch signal around a touch location includes a first function for modeling spread of the touch signal along of first axis of the digitizer sensor and a second function for modeling the spread of the touch signal along a second axis of the digitizer sensor.

Optionally, the function for modeling spread of a touch signal is a three dimensional function that models the spread of the touch signal along a first and second axes of the grid based sensor and over a plurality of sampling periods.

Optionally, the function for modeling spread of a touch signal around a touch location is updated over the course of operation with the digitizer sensor.

Optionally, the method comprises defining each entry in the matrix of data as a ratio between output sampled at a junction during interaction with the digitizer sensor and output sampled at the junction during a calibration procedure with no interaction with the digitizer sensor.

Optionally, a first function for modeling spread of a touch signal is defined for enhancing touch detection, and a second function for modeling spread of a touch signal is defined for enhancing hover detection.

Optionally, a single function for modeling spread of a touch signal is defined across the digitizer sensor.

Optionally, a first function for modeling spread of a touch signal is defined for enhancing fingertip detection and a second function for modeling spread of a touch signal is defined for enhancing stylus detection.

Optionally, the method comprises performing palm rejection on the outputs sampled from the grid based digitizer sensor.

Optionally, input from the palm is removed prior to performing the convolution operation.

Optionally, the convolution operation is performed on a defined portion of the digitizer sensor.

Optionally, the method comprises transforming the matrix of data to the frequency domain; and performing the convolution operation in the frequency domain.

Optionally, the function for modeling spread of a touch signal around a touch location is defined as a convolution matrix, and wherein each entry of the matrix of data in frequency domain is divided entry-wise, by the entry of the convolution matrix in the frequency domain.

Optionally, the matrix of data is reported to a host computer associated with the digitizer sensor and wherein the convolution operation is performed by the host computer.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a simplified block diagram of a known digitizer system that can be can be used with some embodiments of the present invention;

FIG. 1B is a simplified schematic illustration of a mutual capacitance touch detection method that can be used in some embodiments of the present invention;

FIG. 2 is a simplified flow chart of an exemplary method for detecting touch locations from a digitizer sensor, in accordance with some embodiments of the present invention;

FIG. 3 is a simplified schematic illustration of an exemplary image formed from output obtained from a portion of a digitizer sensor prior to de-blurring the image, in accordance with some embodiments of the present invention;

FIG. 4 is a simplified schematic illustration of an exemplary image obtained from a portion of a digitizer sensor after applying two dimensional de-blurring, in accordance with some embodiments of the present invention;

FIG. 5 is a simplified schematic illustration of an exemplary image obtained from a portion of a digitizer sensor after applying one dimensional de-blurring, in accordance with some embodiments of the present invention; and

FIG. 6 is a simplified flow chart of an exemplary method for de-blurring a touch image, in accordance with some embodiments of the present invention.

### DESCRIPTION OF SPECIFIC EMBODIMENTS OF THE INVENTION

The present invention, in some embodiments thereof, relates to touch screens and, more particularly, but not exclusively, to touch detection with a touch screen.

According to some embodiments of the present invention there is provided a method for processing output from a digitizer sensor e.g. a touch screen, to improve detection of a digitizer system during multi-touch interaction with a digitizer sensor. The present inventor has found that effect of touch on the digitizer sensor is typically spread around a touch location so that adjacent fingertip touches and/or adjacent stylus touches may be difficult to discern. Optionally, the methods described herein are used to discern adjacent fingertip hovering and/or adjacent stylus hovering. According to some embodiments of the present invention, a de-blurring technique is applied to the output sampled to localize the data obtained from each touch and/or hover. According to some embodiments of the present invention, the expected spread around a touch location is first predicated and/or simulated and later used to define a function and/or model that can be used for inverting the effect of the spread. Optionally, separate predictions and/or modeling are made for hover and touch. Optionally, output from the digitizer sensor is preprocessed before applying the de-blurring technique. In some exemplary embodiments, the output of the digitizer sensor is presented as matrix of pixels, where each pixel in the matrix is a ratio between the output sampled at a particular junction and sample output obtained from that particular junction while not influenced by touch. Optionally, other methods for removing offset of sampled output from the digitizer sensor are applied.

The present inventor has found that the spread function can differ for different digitizer sensors and/or the touch screens, e.g., digitizer sensor together with an electronic display. In some exemplary embodiments, a de-blurring function is defined for a particular product line. Optionally, a de-blurring function can be defined for a particular user and/or can be modified for a particular user based on sample outputs obtained from that user. Optionally, a first de-blurring function is defined for deciphering between concurrent fingertip touches, and a second de-blurring function is defined for deciphering between concurrent stylus touches. Optionally, different de-blurring functions are defined for detecting a touch location and a hover location. In some exemplary embodiments, de-blurring is performed locally by the digitizer system. In other exemplary embodiments, output from the digitizer sensor is transmitted to a host computer in the form of an image and the de-blurring and/or other image processing is performed by the host.

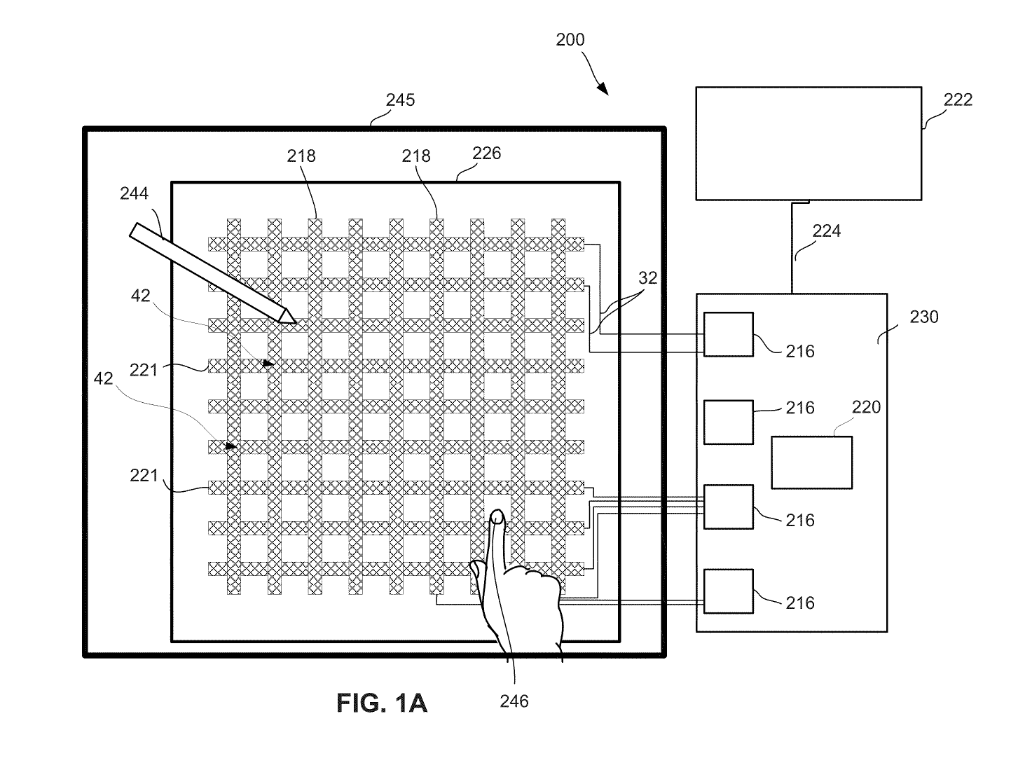

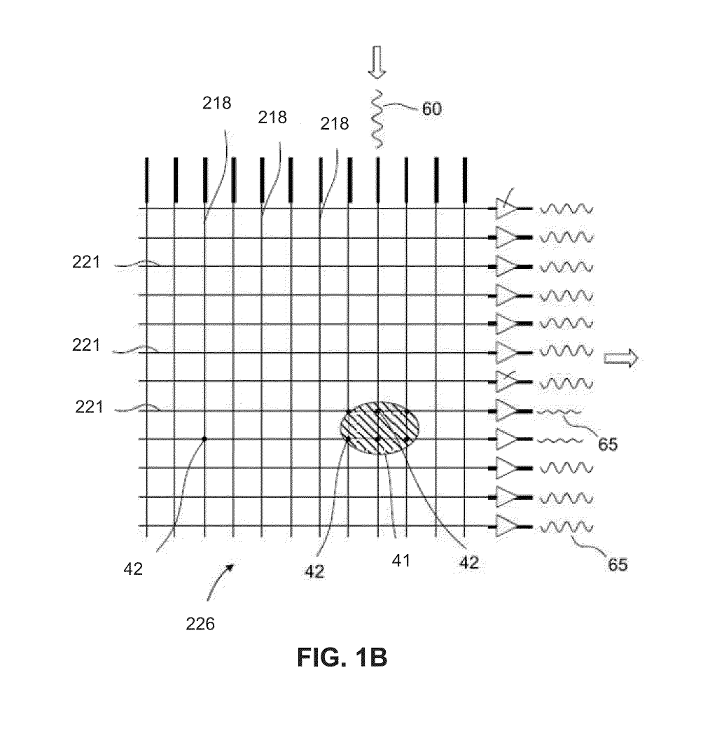

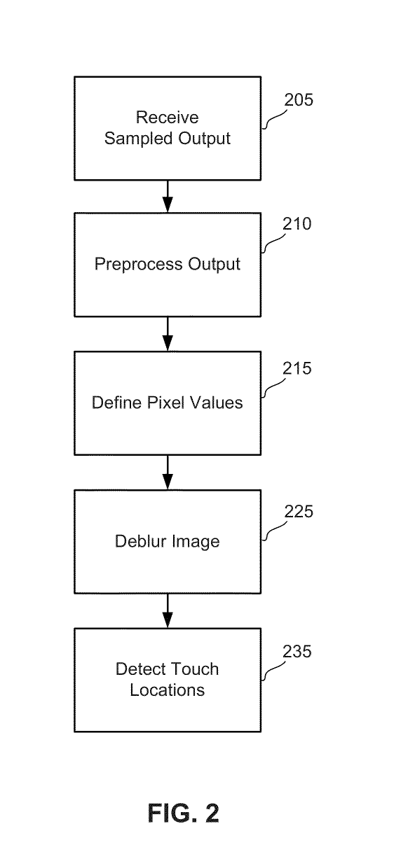

For purposes of better understanding some embodiments of the present invention, as illustrated in FIG. 2-6 of the drawings, reference is first made to the construction and operation of a digitizer system as illustrated in FIGS. 1A and 1B. Digitizer system 200 may be suitable for any computing device that can be operated with stylus and/or fingertip input from a user to the device, e.g. mobile and/or desktop and/or tabletop computing devices that include, for example, FPD screens. Examples of such devices include Tablet PCs, pen enabled lap-top computers, tabletop computers, PDAs or any hand held devices such as palm pilots and mobile phones, or other devices that facilitate electronic gaming.

Digitizer system 200 includes a sensor 226 constructed with patterned arrangement of conductive lines, which is optionally transparent, and which is typically overlaid on a FPD 245. Typically, sensor 226 is a grid based sensor including a set of horizontal conductive lines 221 and a set of vertical conductive lines 218. Sensor 226 can typically detect and/or track position of one or more styluses 244 and/or fingertips 246 interacting with sensor 226. Typically, the parallel conductive lines are spaced at a distance of approximately 2-6.5 mm, e.g. 4 mm apart. The distances typically depend on the size of the FPD and the resolution desired.

Fingertip interaction with sensor 226 is often detected using a mutual capacitance sensing method (FIG. 1B). In some exemplary embodiments, the change in capacitance at one or more junctions 42 in sensor 226 is detected by triggering one or more parallel conductive lines, e.g. one or more of conductive lines 218 or 221 with a triggering signal 60 and detecting signals 65 crossing by virtue of the capacitance to crossing lines. Typically a finger touch on the sensor may span 2-8 lines, e.g. 4 conductive lines.

Typically, the triggering signal is a pulse, sinusoidal and/or AC signal. Typically, the presence of a fingertip touch 41 decreases the amplitude of the coupled signal by 5-30% and thereby can be detected, e.g. decreases the amplitude in reference to a base-line amplitude. Optionally, a finger hovering above the display, i.e. near touch, can also be detected, although the decrease of the signal is generally smaller as compared to the decrease during touch. Optionally, the procedure for detection includes triggering each conductive line along one axis of the sensor, one line at a time, and while sampling signals on all conductive lines along the other axis. Optionally, some conductive lines along one axis of the sensor may be triggered simultaneously with different signals, for example signals differing in their frequency, phase, or the like. This triggering and detecting procedure is typically repeated until all the lines in the active axis have been triggered and interaction in all junction 42 points has been detected.

Typically, circuitry for operating sensor 226 is provided on one or more Printed Circuit Boards (PCBs) 230 positioned on or in the vicinity of sensor 226. One or more Integrated Circuits (ICs) 216 positioned on PCB(s) 230 are electrically connected to conductive lines 218 or 221 in the grid. It is appreciated that only a few connections 32 between conductive lines 218 and 221 ICs 216 are shown for clarity purposes. Typically, ICs 216 function to process signals received from conductive lines 218 and 221 and to sample the sensor's output into a digital representation. The digital output signal is typically forwarded to a digital unit 220, e.g. digital IC unit also on PCB 230, for further digital processing. Typically, ICs 216 and digital unit 220 are also used to generate and/or transmit a triggering signal to one or more conductive lines 216 and 221.

Digital unit 220 together with ICs 216 serves as a controller of digitizer system 200 and/or has functionality of a controller and/or processor. Typically, digital unit 220 together with ICs 216 includes memory and/or memory capability. Output from the digitizer system 200, e.g. calculated position and/or tracking information are typically reported to host computer 222 via interface 224. Optionally, output from digitizer system 200 is further processed by host computer 222 or an application running on host computer 222. Typically host computer 222 is integral to an electronic device.

Digitizer system 200 used to detect stylus and/or fingertip location may be, for example, similar to exemplary digitizer systems described in U.S. Pat. No. 6,690,156, U.S. Pat. No. 7,292,229 and/or U.S. Pat. No. 7,372,455 each of which are incorporated herein by reference.

Reference is now made to FIG. 2 showing a simplified flow chart of an exemplary method for detecting touch locations on a digitizer sensor in accordance with some embodiments of the present invention. According to some embodiments of the present invention, output sampled by a digitizer system is received for processing (block 205). Typically, the output received represents output sensed at each junction of a grid based sensor. Optionally, preprocessing is performed on the output (block 210) to for example remove noise outside an expected range of frequencies for detecting fingertip touch and/or stylus touch. Optionally, High Pass Filters (HPF) are applied for handling touch smearing for example de-blurring or finger separation and/or Low Pass Filters (LPF) are applied to reduce statistical noise. Optionally, further spatial filtering may be used based on the values of the pixels in the neighborhood of the filtered pixel. This may relate to such techniques as median filtering or adaptive threshold application. Optionally, palm rejection is performed to determine if the touch area is obtained from fingertips and/or from other parts of the hand or body.

According to some embodiments of the present invention, a matrix of pixel values is defined which represents change in amplitude in each junction at particular time, relatively to the signal measured when no touch is applied to the sensor (block 215). According to some embodiments of the present invention, each pixel value in the matrix is defined as a ratio between output obtained at a particular junction divided by output obtained at a same junction during a calibration period where no object is touching the junction and/or the digitizer sensor. Typically, by defining the pixel value as a ratio with output obtained during a calibration period, dependence of the output on the amplitude of the triggering signal and/or the parasitic capacitance can be reduced. Alternatively, the corresponding entries in the reference matrix can be subtracted from the value measured in the junction and/or other procedures for removing an offset value can be performed, e.g. procedures that take into consideration output in neighboring pixels.

In one example, when using a triggering signal 60 (FIG. 1B) having an amplitude of 1 unit for triggering a conductive line 218, an output signal 65 having an amplitude of 0.1 unit may be measured in association with a junction of a sensor when no object is touching the junction, while the amplitude of a signal 65 measured in association with a junction touched by a fingertip may for example 0.085, e.g. 15% less than the signal measured when no finger interacts with a junction. In such a case the pixel value of that junction may be defined as 0.85 and/or an integer value obtained by multiplying 0.85 by a maximum defined pixel value, e.g. multiplied by 255. Typically, the output measured in association with a junction of a sensor when no object is touching the junction varies across junctions due to different levels of parasitic capacitance that may appear across the sensor.

According to some embodiments of the present invention, once the matrix of pixel values is defined, an image processing algorithm is applied on the matrix of pixel values, for example to de-blur the image (block 225). The present inventors have found that image processing algorithms for de-blurring can be used to reduce the spread of signal in response to touch, so that adjacent touches can be more clearly discerned. According to some embodiments of the present invention, a location of each touch is detected based on the de-blurred image obtained (block 235).

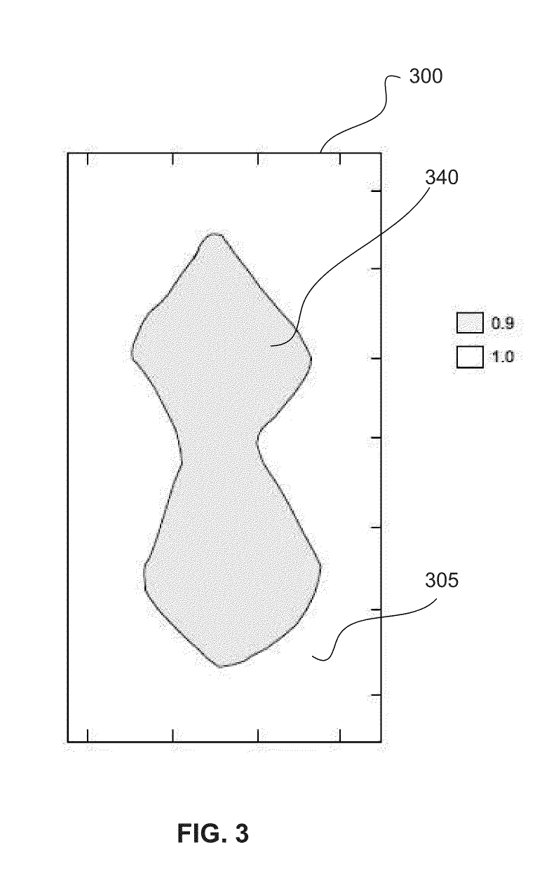

Reference is now made to FIG. 3 showing a simplified schematic illustration of an exemplary touch image formed from output obtained from a portion of a digitizer sensor prior to de-blurring the touch image in accordance with some embodiments of the present invention. According to some embodiments of the present invention, a touch image formed responsive to two fingertips touching a digitizer sensor includes a single detected touch area 340 and a surrounding area 305 that is not touched. In some exemplary embodiments, the image 300 is constructed by defining a matrix of pixel values from the output sampled. In some exemplary embodiments, the matrix of pixel values is constructed per refresh cycle. Alternatively, the matrix of pixel values is constructed and/or updated after a plurality of refresh cycles and/or based on data accumulated over a plurality of refresh cycles. In some exemplary embodiments, each pixel in the matrix represents a ratio between the amplitude measured at a junction and an amplitude measured at a same junction during a calibration process when no touch is present. In exemplary image 300, touch area 340 has a pixel value of 0.9, e.g., covering the range of 0.85-0.95 which corresponds to a 10% reduction in amplitude due to touch, while area 305 has a pixel value of 1.0, e.g. covering a range 0.95-1.05 which corresponds to no touch. In some exemplary embodiments, image 300 does not provide clear indication regarding the number of touches in the image and/or the coordinates of each touch location.

The present inventors have found that de-blurring techniques typically used in image processing can help identify touch locations and/or coordinates. Typically, known de-blurring algorithms attempt to retrieve an ‘original’ or sharp image from a blurred image by first modeling the blur. Typically, the blurred image is defined as a function g(x,y) that equals convolution between a function h(x,y) defining the blur effect and the sharp image ƒ(x,y), e.g. the image without the blur, so that the following relationship is defined:

g(x,y)=ƒ(x,y)*h(x,y) Equation (1)

From this relationship, the sharp image ƒ(x,y) can be retrieved based on the model of the blurring effect h(x,y).

According to some embodiments of the present invention, a blurring matrix that models the spread of an influence of touch on the pixel data is defined and used to obtain clearer touch information from a touch image. According to some embodiments of the present invention, a spread of an influence of touch on the pixel data is modeled during a dedicated procedure based on empirical data and/or simulation. In some exemplary embodiments, the spread of an influence of touch on the pixel data is modeled by using a pointed conductive object to touch the digitizer sensor at a single junction of the sensor, and comparing the output to a straight-forward impulse function at the single junction. In some exemplary embodiments, the spread is modeled e.g. the blurring matrix is defined by analyzing output obtained when a single fingertip is positioned in a pre-defined location. Optionally, the blurring matrix is updated over a course of user operation with a digitizer sensor.

According to some embodiments of the present invention, the matrix of pixel values is defined as a convolution between an image without blur and a two-dimensional blurring function (Equation 1). For example, the convolution matrix may be:

$$h ( x , y ) = [ \begin{matrix}0.1 & 0.3 & 0.1 \\ 0.3 & 1 & 0.3 \\ 0.1 & 0.3 & 0.1\end{matrix} ] \qquad Equation ( 2 )$$

It will be appreciated that other convolution matrices can be used. Optionally, larger matrices can be used. Optionally, the convolution matrix is asymmetrical with respect to its entries and/or its size. In Equation (2), the spread is modeled to be relatively strong (0.3) for neighboring pixels in an X direction and a Y direction and weaker (0.1) in pixels in a diagonal direction. Typically, the effect of the spread is expected to be a function of a distance from the touch location, e.g. as the distance from the touch locations increases the effect of spread decreases. Optionally, a non-symmetrical convolution matrix is defined, e.g. for sensors having different configurations for the X and Y directions, e.g. different sized conductive lines and/or different spaces between the conductive lines in each direction.

In other embodiments of the present invention, two separate one-dimensional blurring functions are determined and the blurred image is defined as follows:

g(x,y)=[ƒ(x,y)*h1(x)*h2(y)] Equation (3)

Optionally, a one dimensional matrix and/or array h1(x) can be defined as:

h1(x)=[0.3 1 0.3] Equation (4)

And a one dimensional matrix and/or array h2(y) can be defined as:

$$h 2 ( y ) = [ \begin{matrix}0.3 \\ 1 \\ 0.3\end{matrix} ] \qquad Equation ( 5 )$$

In some exemplary embodiments, it is assumed that the convolution matrix is constant across the sensor and that is does not depend on the number and position of fingers. Typically, based on this assumption, an inverse of Equation (1) and/or Equation (2) can be determined so that an image ƒ(x,y) providing more localized touch information can be obtained.

By Performing Fourier transform on both sides of Equation (1):

F[g(x,y)]=F[ƒ(x,y)*h(x,y)] Equation (6)

The convolution turns into ordinary multiplication so the relationship is defined as:

G(u,v)=F(u,v)·H(u,v) Equation (7)

Function ƒ(x,y) can then be obtained by applying the inverse Fourier transform on the matrix whose elements are the ratio of corresponding entries in G and H matrices:

$$f ( x , y ) = {ℱ}^{- 1} [ F ( u , v ) ] = {ℱ}^{- 1} [ \frac{G ( u , v )}{H ( u , v )} ] \qquad Equation ( 8 )$$

In some exemplary embodiments, a similar method is applied to Equation (3). It will be appreciated that in some embodiments the sequence of steps can also be performed locally on one or more parts of the matrix, wherein each such part may be associated with its own de-blurring matrix.

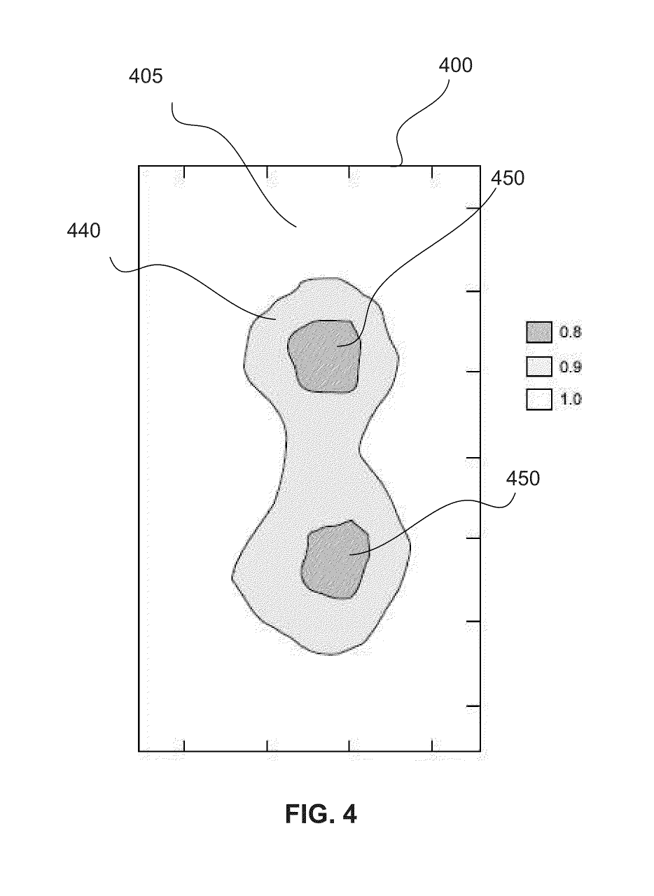

Reference is now made to FIG. 4 showing a simplified schematic illustration of an exemplary image obtained from a portion of a digitizer sensor after applying two dimensional de-blurring in accordance with some embodiments of the present invention. According to some embodiments of the present invention, an image ƒ(x,y) 400 is obtained after de-blurring image 300, e.g. g(x,y) with a two dimensional convolution matrix. According to some embodiments of the present invention, in response to de-blurring, more localized touch areas 450 with higher detection value, e.g. 0.8 appear within a more spread out touch area 440 associated with a lower detection value, e.g. 0.9. Optionally, surrounding area 405 with detection value 1.0 represents an area with no touch detection. In some exemplary embodiments, image 400 provides a clearer indication regarding the number of touches and their location. For example, based on image 400 it is clearer that the initial image 300 (FIG. 3) results from two touches and the location of the touches may be determined within areas 450.

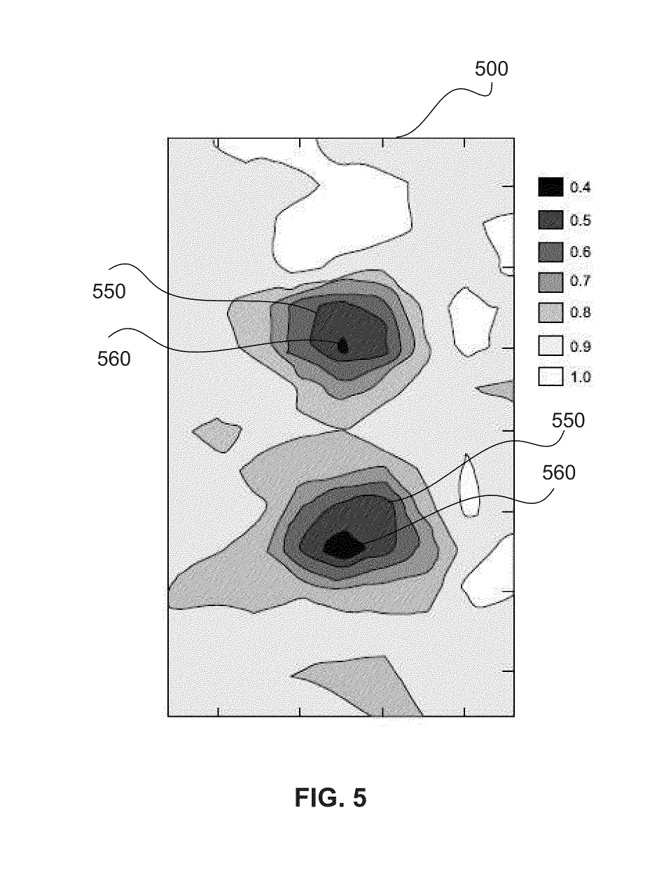

Reference is now made to FIG. 5 showing a simplified schematic illustration of an exemplary image obtained from a portion of a digitizer sensor after applying one dimensional de-blurring in accordance with some embodiments of the present invention. According to some embodiments of the present invention, an image ƒ(x,y) 500 is obtained after de-blurring image 300, e.g. g(x,y) with two one-dimensional convolution arrays and/or matrices. Optionally, applying two one-dimensional convolution arrays can improve a resolution of image 300 and introduce a plurality of different detection levels, e.g. 0.4-0.9. Optionally, in such a case touch areas can be identified as areas 550 or 560.

In some exemplary embodiments, convoluting with two 1-dimensional vector provides better touch recognition than convoluting with a 2-dimensional matrix. However, in other exemplary embodiments, the opposite may occur. Each of the two convolutions may provide different results with different convolution matrix or vectors. Optionally, a different method for de-blurring a touch image is defined based on empirical data and for a particular system. For example, for some systems convoluting with a 2-dimensional matrix may provide better results, while in other systems convoluting with a 1-dimensional matrix may provide better results. It is to be understood that the reliability of the information obtained from the de-blurred image depends on the robustness of the convolution matrix that defines the blur. It will be appreciated that the de-blurring method described above is exemplary only and intended to provide an exemplary implementation. Other implementations for applying de-blurring techniques to a touch image may be used.

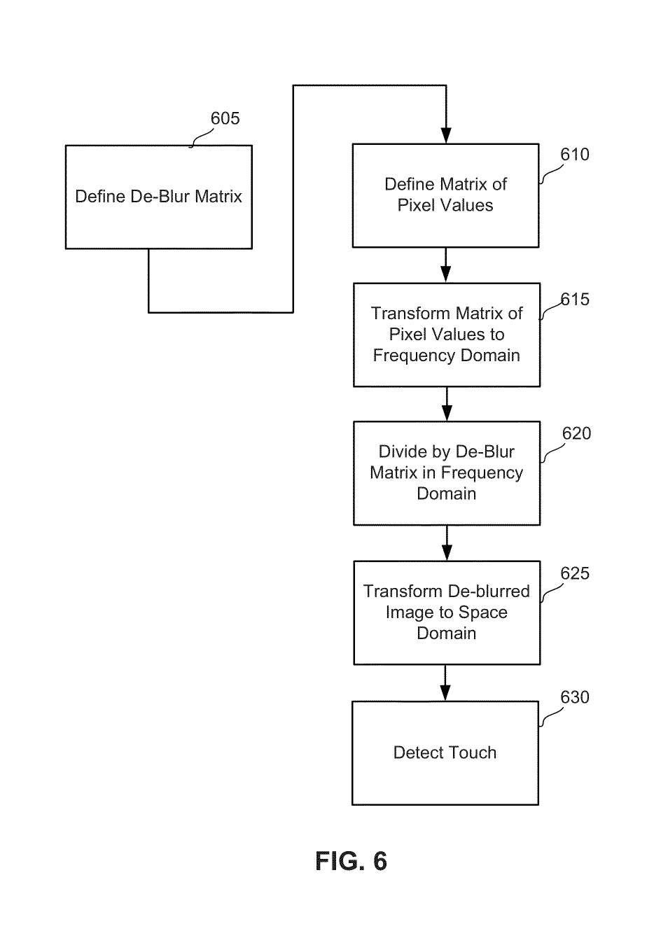

Reference is now made to FIG. 6 showing a simplified flow chart of an exemplary method for de-blurring a touch image in accordance with some embodiments of the present invention. According to some embodiments of the present invention, a de-blurring matrix and/or function is defined during a dedicated procedure (block 605). Typically, the de-blurring function is defined during manufacturing and stored in memory of a digitizer system and/or associated host computer. Optionally, the de-blurring function can be updated and/or changed over time based on input received from a user during its operation and/or based on sampled output from a user, e.g. based on input received and/or output sampled by a particular user.

According to some embodiments of the present invention, during operation of the digitizer sensor, output from the digitizer sensor is sampled and a matrix of pixel values is defined (block 610). In some exemplary embodiments, a matrix of pixel values is defined wherein each entry is the ratio between output sampled and reference values sampled from the sensor during a period of no interaction with the sensor. In some embodiments, the output sampled is subtracted from reference values that are either sampled from the sensor during a period of no interaction with the sensor or otherwise defined. Optionally, the matrix of pixel values is simply defined as the output sampled by the digitizer sensor. Optionally, preprocessing of data sampled from the digitizer sensor is performed on output sampled and/or on the defined matrix of pixel values, e.g. for smoothing and/or noise removal.

According to some embodiments of the present invention, the matrix of pixel values is transformed to a frequency domain (block 615) and the matrix of pixel values in the frequency domain is divided, entry-wise, by the corresponding entries of de-blurring matrix in the frequency domain (block 620). According to some embodiments of the present invention, once the de-blurring matrix is applied across the matrix of pixel values, the now de-blurred image ƒ(x,y) is transformed back to the space domain (block 625). According to some embodiments of the present invention, touch detection is performed on the de-blurred image ƒ(x,y) (block 630). In some exemplary embodiments, de-blurring is performed by a digitizer system 200, e.g. by digital unit 220 (FIG. 1B) and the touch coordinates are reported to host 222. In some exemplary embodiments, the matrix of pixel values is reported to host 222 for further processing. It will be appreciated that the de-blurring method described above is exemplary only and intended to provide one possible implementation. Other implementations for applying de-blurring techniques may be used.

It will also be appreciated that additionally or alternatively, other image processing techniques can be applied. Optionally, 3-dimensional (3D) techniques may be used when considering two or more images taken at different points in time. Optionally, preprocessing includes 3D filtering based data obtained over a plurality of sampling periods. Optionally, further 1D, 2D or 3D processing may relate to sorting, for example analyzing the distribution of the measured values, optionally by using histograms. By analyzing the average and standard deviation of the distribution, thresholds can be better selected by outlier removal, thus increasing the robustness of the system.

Yet another group of image analysis techniques that may be applied refers to simulation. By simulating touches, significant components of the signal or the noise may be captured and later used for touch recognition. For example, some simulations can provide information or parameters for the algorithms, such as weight values required for spatial algorithms, parameters required for the de-blurring application described, or the like. Additional usage of simulations may relate to supplying exemplary images representing certain touch scenarios, and by applying template matching, using the images for determining touch locations. Simulations may thus assist in image degradation or restoration process; constructing noise models; restoration in the presence of noise only, i.e. spatial filtering; periodic noise reduction by frequency domain filtering or others.

An additional image processing technique that can be applied relates to color image processing, wherein a touch map can be viewed as 2 separate color maps, one relating to the magnitude, i.e. to the signal level, and the other relating to another characteristic of the signal such as the phase. By analyzing the two maps additional information can be retrieved. Yet another image processing technique may relate to image compression. By compressing the image of measured signals, it can efficiently be passed from the touch sensor to the host. This will enable to pass to the host not only the touch locations as recognized, but further information. Since the host generally has more significant processing power, it can extract the touch locations at higher rate, or can retrieve additional information. It will be appreciated that compression can use 1D 2D or 3D compression techniques, wherein 3D techniques may relate to compressing a multiplicity images by representing the changes between consecutive images.

Applying morphological operators such as erosion or dilation to a map representing the measured or manipulated values may also prove useful in shapes analysis of touch images, for example for the determination of single versus multiple fingers touch. Learning or classification algorithms as used in image processing may also be used, for example towards applications such as learning the shape of the hand, palm, thumb and fingers of a user, differentiating between fingers, learning reference images for improving ungrounded touch interpretation as discussed above in association with simulation, or others.

Yet another type of image-analysis techniques that may be used refers to de-bending algorithms. Since a digitizer sensor may be attached to the display device only at some points of its outer boundary, the received values may be affected by the movement of the sensor in a direction perpendicular to the sensor, which may be corrected by using de-bending algorithms, which identify the existence of bending, cancel out the background effects. It should be appreciated, that such an algorithm provides also information about the pressure level applied by the operator, which may be used by the host applications to apply actions in response to the different pressure levels.

Further image analysis techniques may refer to background estimation and correction, for analyzing the effect of changes in the temperature or other environment parameters on the measured values. By fitting the image information gathered without touch to a plane or a surface, the updated background can be removed to more accurately obtain the touch locations.

It will be appreciated that although most of the embodiments of the present invention have been described in reference to detecting locations of two fingertip touches the methods described herein can be applied to detecting location of more than two fingertip touches, to two or more stylus touches, and/or to a plurality of fingertip and stylus hovering.

It will also be appreciated that a simpler algorithm such as interpolation may be used for more accurately recognizing touch locations.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

What is claimed is:

1. A method for identifying input to a digitizer sensor, the method comprising:
defining a function for modeling spread of a touch signal around a touch location;
defining a matrix of data from outputs sampled from a grid based digitizer sensor, wherein the grid based digitizer sensor defines a grid of junctions, and wherein entries in the matrix correspond to outputs at junctions of the grid based sensor;
performing a convolution operation on the matrix of data based on the function defined for modeling spread of the touch signal, the convolution operation providing an updated matrix of data with enhanced touch information; and
detecting coordinates of the input to the digitizer sensor from the updated matrix of data.

2. The method according to claim 1, where the function for modeling spread of a touch signal around a touch location is a two dimensional function that defines the spread of a touch signal along a first and second axis of the grid based sensor.

3. The method according to claim 1, wherein the function for modeling spread of a touch signal around a touch location includes a first function for modeling spread of the touch signal along of first axis of the digitizer sensor and a second function for modeling the spread of the touch signal along a second axis of the digitizer sensor.

4. The method according to claim 1, wherein the function for modeling spread of a touch signal is a three dimensional function that models the spread of the touch signal along a first and second axes of the grid based sensor and over a plurality of sampling periods.

5. The method according to claim 1, wherein the function for modeling spread of a touch signal around a touch location is updated over the course of operation with the digitizer sensor.

6. The method according to claim 1, comprising defining each entry in the matrix of data as a ratio between output sampled at a junction during interaction with the digitizer sensor and output sampled at the junction during a calibration procedure with no interaction with the digitizer sensor.

7. The method according to claim 1, wherein a first function for modeling spread of a touch signal is defined for enhancing touch detection, and a second function for modeling spread of a touch signal is defined for enhancing hover detection.

8. The method according to claim 1, wherein a single function for modeling spread of a touch signal is defined across the digitizer sensor.

9. The method according to claim 1, wherein a first function for modeling spread of a touch signal is defined for enhancing fingertip detection and a second function for modeling spread of a touch signal is defined for enhancing stylus detection.

10. The method according to claim 1, comprising performing palm rejection on the outputs sampled from the grid based digitizer sensor.

11. The method according to claim 10, wherein input from the palm is removed prior to performing the convolution operation.

12. The method according to claim 1, wherein the convolution operation is performed on a defined portion of the digitizer sensor.

13. The method according to claim 1, comprising transforming the matrix of data to the frequency domain; and performing the convolution operation in the frequency domain.

14. The method according to claim 13, wherein the function for modeling spread of a touch signal around a touch location is defined as a convolution matrix, and wherein each entry of the matrix of data in frequency domain is divided entry-wise, by the entry of the convolution matrix in the frequency domain.

15. The method according to claim 1, wherein the matrix of data is reported to a host computer associated with the digitizer sensor and wherein the convolution operation is performed by the host computer.
